(19) United States
(12) Patent Application Publication
(10) Pub. No.: US 2015/0024931 A1
(43) Pub. Date: Jan. 22, 2015

(54) NUCLEOPHILIC POROUS CARBON MATERIALS FOR REVERSIBLE CO2 CAPTURE

(71) Applicants: James M. Tour, Bellaire, TX (US); Chih-Chau Hwang, Houston, TX (US); Josiah Tour, Bellaire, TX (US)

(72) Inventors: James M. Tour, Bellaire, TX (US); Chih-Chau Hwang, Houston, TX (US); Josiah Tour, Bellaire, TX (US)

(73) Assignee: William Marsh Rice University, Houston, TX (US)

(21) Appl. No.: 14/315,920

(22) Filed: Jun. 26, 2014

Related U.S. Application Data
(60) Provisional application No. 61/839,567, filed on Jun. 26, 2013.

(51) Int. Cl. B01D 53/04; B01J 20/28; B01J 20/24; B01J 20/20

(52) U.S. Cl. CPC B01D 53/0407; B01J 20/20; B01J 20/28066; B01J 20/28083; B01J 20/28085; B01J 20/28011; B01J 20/24; B01D 2253/202; B01D 2253/102; B01D 2253/1124; B01D 2253/1128; B01D 2257/504
USPC 502/402; 95/139; 423/230; 502/400; 502/401; 502/403

(57) ABSTRACT

In some embodiments, the present disclosure pertains to methods of capturing CO₂ from an environment by associating the environment (e.g., a pressurized environment) with a porous carbon material that comprises a plurality of pores and a plurality of nucleophilic moieties. In some embodiments, the associating results in sorption of CO₂ to the porous carbon materials. In some embodiments, the sorption of CO₂ to the porous carbon materials occurs selectively over hydrocarbons in the environment. In some embodiments, the methods of the present disclosure also include a step of releasing captured CO₂ from porous carbon materials. In some embodiments, the releasing occurs without any heating steps by decreasing environmental pressure. In some embodiments, the methods of the present disclosure also include a step of disposing released CO₂ and reusing porous carbon materials. Additional embodiments of the present disclosure pertain to porous carbon materials that are used for CO₂ capture.

### CROSS-REFERENCE TO RELATED APPLICATIONS

This application claims priority to U.S. Provisional Patent Application No. 61/839,567, filed on Jun. 26, 2013. The entirety of the aforementioned application is incorporated herein by reference.

### STATEMENT REGARDING FEDERALLY SPONSORED RESEARCH

Not applicable.

### BACKGROUND

Current methods and materials for capturing CO₂ from an environment suffer from numerous limitations, including low CO₂ selectivity, limited CO₂ sorption capacity, and the need for stringent reaction conditions. The CO₂ sorbents and CO₂ capture methods of the present disclosure address these needs.

### SUMMARY

In some embodiments, the present disclosure pertains to methods of capturing CO₂ from an environment. In some embodiments, the methods comprise a step of associating the environment with a porous carbon material. In some embodiments, the porous carbon material comprises a plurality of pores and a plurality of nucleophilic moieties. In some embodiments, the associating results in sorption of the CO₂ to the porous carbon material.

The methods of the present disclosure may be utilized to capture CO₂ from various environments. In some embodiments, the environments include, without limitation, industrial gas streams, natural gas streams, natural gas wells, industrial gas wells, oil and gas fields, and combinations thereof. In some embodiments, the environment is a pressurized environment with a total pressure that is higher than atmospheric pressure (e.g., 5 bar to 500 bar).

In some embodiments, porous carbon materials are associated with an environment by placing the porous carbon materials at or near the environment. In some embodiments, porous carbon materials are associated with an environment by flowing the environment through a structure that contains the porous carbon materials.

In some embodiments, the sorption of the CO₂ to the porous carbon materials occurs above atmospheric pressure (e.g., 5 bar to 500 bar). In some embodiments, the sorption of the CO₂ to the porous carbon materials occurs at a partial CO₂ pressure of about 0.1 bar to about 100 bar. In some embodiments, the sorption of the CO₂ to the porous carbon materials occurs at ambient temperature without any heating steps. In some embodiments, the sorption of the CO₂ to the porous carbon materials occurs selectively over hydrocarbons in the environment. In some embodiments, the CO₂ is converted to poly(CO₂) within the pores of the porous carbon materials.

In some embodiments, the methods of the present disclosure also include a step of releasing the captured CO₂ from the porous carbon materials. In some embodiments, the releasing occurs by decreasing the pressure of the environment. In some embodiments, the releasing occurs by placing the porous carbon materials in a second environment that has a lower pressure than the environment where CO₂ capture occurred. In some embodiments, the releasing occurs at pressures ranging from about 0 bar to about 100 bar. In some embodiments, the releasing occurs at ambient temperature or the same temperature at which CO₂ sorption occurred. In some embodiments, the releasing occurs without heating the porous carbon materials. In some embodiments, the releasing occurs through depolymerization of formed poly(CO₂).

In some embodiments, the methods of the present disclosure also include a step of disposing the released CO₂. In some embodiments, the methods of the present disclosure also include a step of reusing the porous carbon material after the releasing step to capture additional CO₂ from an environment.

The methods of the present disclosure can utilize various porous carbon materials. Additional embodiments of the present disclosure pertain to such porous carbon materials for CO₂ capture. Generally, such porous carbon materials comprise a plurality of pores and a plurality of nucleophilic moieties.

In some embodiments, the porous carbon materials include, without limitation, nucleophilic polymers, polypeptides, proteins, waste materials, nitrogen-containing porous carbon materials, sulfur-containing porous carbon materials, metal-containing porous carbon materials, metal oxide-containing porous carbon materials, metal sulfide-containing porous carbon materials, phosphorus-containing porous carbon materials, and combinations thereof. In some embodiments, the porous carbon materials include a nucleophilic polymer. In some embodiments, the nucleophilic polymer includes, without limitation, nitrogen-containing polymers, sulfur-containing polymers, polythiophene (PTH), polythiophene-methanol (also called 2-(hydroxymethyl)thiophene), polyacrylonitrile (PAN), polypyrrole, and combinations thereof. In some embodiments, the nucleophilic polymer is carbonized. In some embodiments the nucleophilic carbon polymer is carbonized and reduced.

In some embodiments, the nucleophilic moieties are part of the porous carbon materials. In some embodiments, the nucleophilic moieties are embedded within the pores of the porous carbon materials. In some embodiments, the nucleophilic moieties include, without limitation, primary nucleophiles, secondary nucleophiles, tertiary nucleophiles and combinations thereof. In some embodiments, the nucleophilic moieties include, without limitation, oxygen-containing moieties, sulfur-containing moieties, metal-containing moieties, metal oxide-containing moieties, metal sulfide-containing moieties, phosphorus-containing moieties, nitrogen-containing moieties, and combinations thereof.

The porous carbon materials of the present disclosure may have various properties. For instance, in some embodiments, the porous carbon materials of the present disclosure have surface areas ranging from about 1,000 m²/g to about 3,000 m²/g. In some embodiments, the pores in the porous carbon materials have diameters ranging from about 5 nm to about 100 nm. In some embodiments, the pores in the porous carbon materials have volumes ranging from about 1 cm³/g to about 10 cm³/g. In some embodiments, the porous carbon materials have densities ranging from about 0.3 g/cm³ to about 4 g/cm³. In some embodiments, the porous carbon materials have CO₂ sorption capacities ranging from about 10% to about 200% of the porous carbon material weight. In some embodiments, the porous carbon materials have CO₂ sorption capacities of about 55% to about 90% of the porous carbon material weight.

### DESCRIPTION OF THE FIGURES

FIG. 1 provides a scheme of a method of capturing carbon dioxide (CO₂) from an environment.

FIG. 2 provides synthetic schemes and micrographic images of various porous carbon materials. FIG. 2A provides a scheme for the synthesis of sulfur-containing porous carbon (SPC) or nitrogen containing porous carbon (NPC) by treating poly[(2-hydroxymethyl)thiophene] or poly(acrylonitrile) with KOH at 600° C. and then washing with dilute HCl and water until the extracts are neutral. The NPC is further reduced using 10% H₂ at 600° C. to form reduced NPC (R-NPC). The synthetic details are described in Example 1. FIG. 2B provides a scanning electron microscopy (SEM) image of NPCs at a scale bar of 100 μm. FIG. 2C provides an SEM image of SPCs at a scale bar of 500 nm. FIG. 2D provides a transmission electron microscopy (TEM) image of the SPCs in FIG. 2B at a scale bar of 25 nm.

FIG. 3 provides x-ray photoelectron spectroscopy (XPS) of SPCs (left panel) and NPCs (right panel). The XPS indicates 13.3 atomic % of S in the SPC precursor and 22.4 atomic % of N in the NPC precursor. The resulting SPC and NPC then had 8.1 atomic % of S content and 6.2 atomic % of N content, respectively. The S₂ₚ and N₁ₛ XPS peaks were taken from the SPC and NPC. The S₂ₚ core splits into two main peaks of 163.7 (2p_{3/2}) and 164.8 eV (2p_{1/2}), which correspond to thiophenic sulfur atoms incorporated into the porous carbon framework via the formation of C—S—C bond. The N₁ₛ reflects two different chemical environments: pyridinic nitrogen (N-6) and pyrrolic nitrogen (N-5) atoms.

FIG. 4 provides data relating to CO₂ uptake measurements for SPCs. FIG. 4A provides volumetric and gravimetric uptake of CO₂ on SPC at different temperatures and pressures. Data designated with (*) were recorded volumetrically at Rice University. Data designated with (§) were performed volumetrically at the National Institute of Standards and Technology (NIST). Data designated with (+) were measured gravimetrically at NIST. All gravimetric measurements were corrected for buoyancy. FIGS. 4B-D provide three consecutive CO₂ sorption-desorption cycles on the SPC over a pressure range from 0 to 30 bar at 30° C. All solid circles indicate CO₂ sorption, while the open circles designate the desorption process. FIG. 4E provides volumetric SPC CO₂ sorption isotherms at 23° C. and 50° C. over a pressure range from 0 to 1 bar.

FIG. 5 provides pictorial descriptions of excess and absolute CO₂ uptake. FIG. 5A is adapted from Chem. Sci. 5, 32-51 (2014). The blue dashed line indicates the Gibbs dividing surface. It divides the free volume into two regions in which gas molecules are either in an adsorbed or bulk state. FIG. 5B shows a depiction of total uptake, which can be used as an approximation for absolute uptake for microporous materials with negligible external surface areas.

FIG. 6 shows CO₂ uptake on the SPC. Comparison of absolute uptake and excess uptake at 22° C. and 50° C. exemplifies the small differences over this pressure and temperature range.

FIG. 7 shows spectral changes before and after sorption-desorption at 23° C. and the proposed polymerization mechanism. Attenuated total reflectance infrared spectroscopy (ATR-IR) (FIGS. 7A-B), Raman spectroscopy (FIG. 7C) and 50.3 MHz ¹³C MAS NMR spectra (FIG. 7D) are shown before and after CO₂ sorption at 10 bar and room temperature. All spectra were recorded at the elapsed times indicated on the graphs after the SPC sorbent was returned to ambient pressure. In the NMR experiments, the rotor containing the SPC was tightly capped during the analyses. For the third NMR experiment (top), the same material was left under ambient conditions for 19 h before being repacked in the rotor to obtain the final spectrum. Each NMR spectrum took 80 min to record. Example 1 provides more details. FIGS. 7E-F show proposed mechanisms that illustrate the poly(CO₂) formation in SPC or NPC, respectively, in a higher pressure CO₂ environment. With the assistance of the nucleophile, such as S or N, the CO₂ polymerization reaction is initiated under pressure, and the polymer is further likely stabilized by the van der Waals interactions with the carbon surfaces in the pores.

FIG. 8 shows ATR-IR (FIG. 8A) and Raman (FIG. 8B) spectra for the ZIF-8 before and after CO₂ sorption at 10 bar. All spectra were recorded 3 and 20 minutes after the ZIF-8 sorbent was returned to ambient pressure at room temperature.

FIG. 9 shows ATR-IR (FIG. 9A) and Raman (FIG. 9B) spectra for the activated carbon before and after CO₂ sorption at 10 bar. Spectra were taken 3 min and 20 min after the activated carbon was returned to ambient pressure at room temperature.

FIG. 10 provides volumetric gas uptake data. FIG. 10A provides data relating to volumetric CO₂ uptake performance at 30° C. of SPC, NPC, R-NPC and the following traditional sorbents: activated carbon, ZIF-8, and zeolite 5A. Aluminum foil was used as a reference to ensure no CO₂ condensation was occurring in the system at this temperature and pressure. Volumetric CO₂ and CH₄ uptake tests at 23° C. on SPC (FIG. 10B), activated carbon (FIG. 10C) and ZIF-8 sorbents (FIG. 10D) are also shown.

FIG. 11 shows various mass spectrometry (MS) data. FIG. 11A shows MS data that was taken while the system was being pressurized with a premixed gas of CO₂ in natural gas during the uptake process. FIG. 11B shows MS data that was recorded while the premixed gas-filled SPC was desorbing from 30 bar. The mixed gas was purchased from Applied Gas Inc.

FIG. 12 provides comparative data relating to the CO₂ uptake capacities of various carbon sources.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Traditional solid CO₂ sorbents, such as activated carbons and zeolites, show moderate CO₂ sorption capacity due to their high surface area. Moreover, the selectivity of such sorbents to CO₂ is very low, thereby limiting their application in oil and gas fields where CO₂ is present in the presence of hydrocarbon gases and other small organic and inorganic gases.

Although amine polymer modified silica show good CO₂ selectivity and uptake capacity, they require much more energy for regeneration. For instance, amine polymer modified silica may typically be heated to temperatures above 100° C. in order to be regenerated.

Aqueous sorbents (e.g., aqueous amine scrubbers) are also used to remove CO₂ from natural gas. However, many aqueous sorbents such as aqueous amines are corrosive. Moreover, CO₂-containing liquids require stringent heating (e.g., heating at temperatures between 125-140° C.) to liberate the CO₂ from the aqueous sorbent (e.g., amine carbonate).

Other materials for CO₂ capture include metal oxide frameworks (MOFs), zeolites, ionic liquids, cryogenic distillation, membranes and metal oxides. However, many of such materials have hydrolytic instabilities or low densities that lead to low volumetric efficiencies or poor selectivity relative to methane or other hydrocarbons. Moreover, synthesis constraints or energy costs associated with these materials lessen their suitability for on-site CO₂ capture from various environments, such as environments containing natural gas streams.

As such, a need exists for improved CO₂ sorbents and CO₂ capture methods that can be used to capture CO₂ more effectively and selectively without requiring stringent conditions, such as temperature swings. The present disclosure addresses these needs.

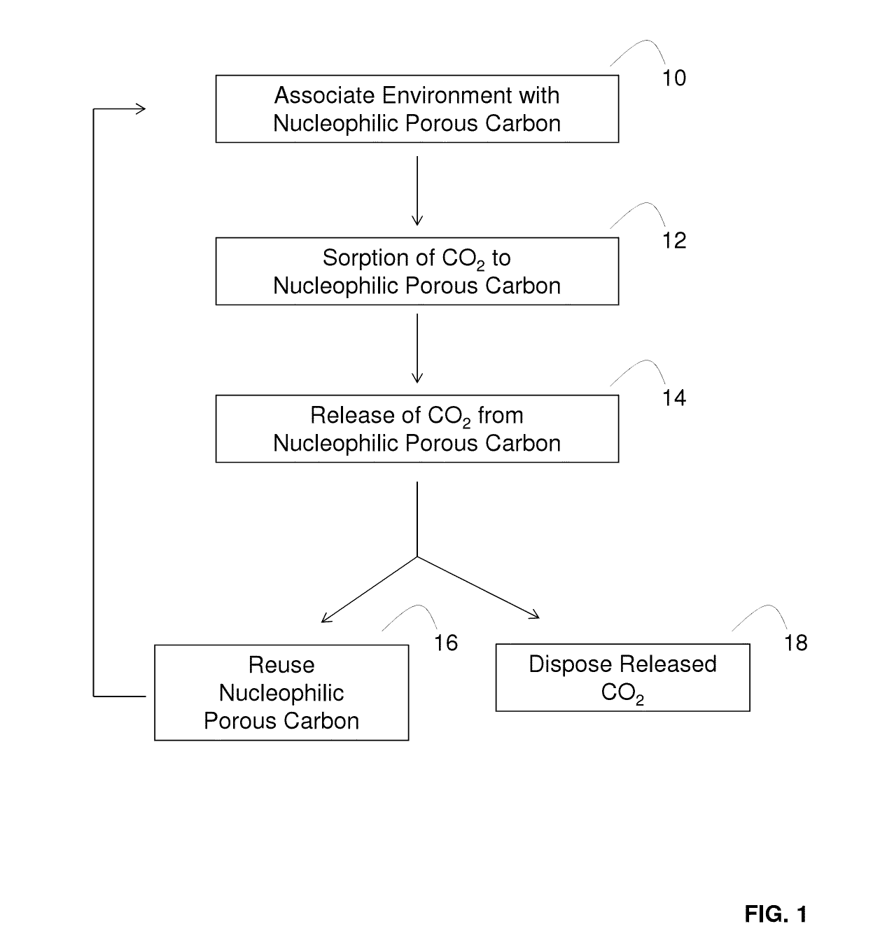

In some embodiments, the present disclosure pertains to methods of capturing CO₂ from an environment by utilizing various porous carbon materials that include a plurality of pores and a plurality of nucleophilic moieties (also referred to as nucleophilic porous carbons). In some embodiments illustrated in FIG. 1, the CO₂ capture methods of the present disclosure include a step of associating the environment with the porous carbon material (step 10), such as a nitrogen-containing or a sulfur-containing porous carbon material. In some embodiments, the associating results in the sorption of the CO₂ to the porous carbon material (step 12). In some embodiments, the sorption occurs selectively in a pressurized environment, such as a subsurface oil and gas well.

In some embodiments, the methods of the present disclosure also include a step of releasing the captured CO₂ from the porous carbon material (step 14). In some embodiments, the releasing occurs by decreasing environmental pressure in the absence of a heating step.

In additional embodiments, the methods of the present disclosure also include a step of reusing the porous carbon material after the releasing step for additional CO₂ capture (step 16). In some embodiments, the methods of the present disclosure also include a step of disposing the released CO₂ (step 18). Further embodiments of the present disclosure pertain to the porous carbon materials that are utilized for CO₂ capture.

As set forth in more detail herein, the CO₂ capture methods and the porous carbon materials of the present disclosure have numerous embodiments. For instance, various methods may be utilized to associate various types of porous carbon materials with various environments to result in the capture of various amounts of CO₂ from the environment. Moreover, the captured CO₂ may be released from the porous carbon materials in various manners.

Environments

The methods of the present disclosure may be utilized to capture CO₂ from various environments. In some embodiments, the environment includes, without limitation, industrial gas streams, natural gas streams, natural gas wells, industrial gas wells, oil and gas fields, and combinations thereof. In some embodiments, the environment is a subsurface oil and gas field. In more specific embodiments, the methods of the present disclosure may be utilized to capture CO₂ from an environment that contains natural gas, such as an oil well.

In some embodiments, the environment is a pressurized environment. For instance, in some embodiments, the environment has a total pressure higher than atmospheric pressure.

In some embodiments, the environment has a total pressure of about 0.1 bar to about 500 bar. In some embodiments, the environment has a total pressure of about 5 bar to about 100 bar. In some embodiments, the environment has a total pressure of about 25 bar to about 30 bar. In some embodiments, the environment has a total pressure of about 100 bar to about 200 bar. In some embodiments, the environment has a total pressure of about 200 bar to about 300 bar.

Association of Porous Carbon Materials with an Environment

Various methods may be utilized to associate porous carbon materials of the present disclosure with an environment. In some embodiments, the association occurs by incubating the porous carbon materials with the environment (e.g., a pressurized environment). In some embodiments, the association of porous carbon materials with an environment occurs by flowing the environment through a structure that contains the porous carbon materials. In some embodiments, the structure may be a column or a sheet that contains immobilized porous carbon materials. In some embodiments, the structure may be a floating bed that contains porous carbon materials.

In some embodiments, the porous carbon materials are suspended in a solvent while being associated with an environment. In more specific embodiments, the solvent may include water or alcohol. In some embodiments, the porous carbon materials are associated with an environmental in pelletized form. In some embodiments, the pelletization can be used to assist flow of the gases through the porous carbon materials.

In some embodiments, the associating occurs by placing the porous carbon material at or near the environment. In some embodiments, such placement occurs by various methods that include, without limitation, adhesion, immobilization, clamping, and embedding. Additional methods by which to associate porous carbon materials with an environment can also be envisioned.

CO₂ Sorption to Porous Carbon Materials

The sorption of CO₂ to porous carbon materials of the present disclosure can occur at various environmental pressures. For instance, in some embodiments, the sorption of CO₂ to porous carbon materials occurs above atmospheric pressure. In some embodiments, the sorption of CO₂ to porous carbon materials occurs at total pressures ranging from about 0.1 bar to about 500 bar. In some embodiments, the sorption of CO₂ to porous carbon materials occurs at total pressures ranging from about 5 bar to about 500 bar. In some embodiments, the sorption of CO₂ to porous carbon materials occurs at total pressures ranging from about 5 bar to about 100 bar. In some embodiments, the sorption of CO₂ to porous carbon materials occurs at total pressures ranging from about 25 bar to about 30 bar. In some embodiments, the sorption of CO₂ to porous carbon materials occurs at total pressures ranging from about 100 bar to about 500 bar. In some embodiments, the sorption of CO₂ to porous carbon materials occurs at total pressures ranging from about 100 bar to about 300 bar. In some embodiments, the sorption of CO₂ to porous carbon materials occurs at total pressures ranging from about 100 bar to about 200 bar.

In some embodiments, the sorption of CO₂ to porous carbon materials occurs at a partial CO₂ pressure of about 0.1 bar to about 100 bar. In some embodiments, the sorption of CO₂ to porous carbon materials occurs at a partial CO₂ pressure of about 5 bar to about 30 bar. In some embodiments, the sorption of CO₂ to porous carbon materials occurs at a partial CO₂ pressure of about 30 bar.

The sorption of CO₂ to porous carbon materials can also occur at various temperatures. For instance, in some embodiments, the sorption of CO₂ to porous carbon materials occurs at temperatures that range from about 0° C. (e.g., a sea floor temperature where a wellhead may reside) to about 100° C. (e.g., a temperature where machinery may reside). In more specific embodiments, the sorption of CO₂ to porous carbon materials occurs at ambient temperature (e.g., temperatures ranging from about 20-25° C., such as 23° C.). In some embodiments, the sorption of CO₂ to porous carbon materials occurs below ambient temperature. In some embodiments, the sorption of CO₂ to porous carbon materials occurs above ambient temperature. In some embodiments, the sorption of CO₂ to porous carbon materials occurs without the heating of the porous carbon materials.

Without being bound by theory, it is envisioned that the sorption of CO₂ to porous carbon materials occurs by various molecular mechanisms. For instance, in some embodiments, the sorption of CO₂ to porous carbon materials occurs by at least one of absorption, adsorption, ionic interactions, physisorption, chemisorption, covalent bonding, non-covalent bonding, hydrogen bonding, van der Waals interactions, and combinations of such mechanisms. In some embodiments, the sorption includes an absorption interaction between the CO₂ in an environment and the porous carbon materials. In some embodiments, the sorption includes an ionic interaction between the CO₂ in an environment and the porous carbon materials. In some embodiments, the sorption includes an adsorption interaction between the CO₂ in an environment and the porous carbon materials. In some embodiments, the sorption includes a physisorption interaction between the CO₂ in an environment and the porous carbon materials. In some embodiments, the sorption includes a chemisorption interaction between the CO₂ in an environment and the porous carbon materials. In some embodiments, the sorption includes a covalent bonding interaction between the CO₂ in an environment and the porous carbon materials. In some embodiments, the sorption includes a non-covalent bonding interaction between the CO₂ in an environment and the porous carbon materials. In some embodiments, the sorption includes a hydrogen bonding interaction between the CO₂ in an environment and the porous carbon materials. In some embodiments, the sorption includes a van der Waals interaction between the CO₂ in an environment and the porous carbon materials. In some embodiments, the sorption of CO₂ to porous carbon materials occurs by adsorption and absorption.

Without being bound by theory, it is envisioned that CO₂ sorption may be facilitated by various chemical reactions. For instance, in some embodiments, the sorbed CO₂ is converted to poly(CO₂) within the pores of the porous carbon materials. In some embodiments, the poly(CO₂) comprises the following formula: —(O—C(═O))ₙ—, where n is equal to or greater than 2. In some embodiments, n is between 2 to 10,000. In some embodiments, the formed poly(CO₂) may be further stabilized by van der Waals interactions with the carbon surfaces in the pores of the carbon materials. In some embodiments, the formed poly(CO₂) may be in solid form.

In some embodiments, the sorption of CO₂ to the porous carbon materials occurs selectively. For instance, in some embodiments, the sorption of CO₂ to the porous carbon materials occurs selectively over hydrocarbons in the environment (e.g., ethane, propane, butane, pentane, methane, and combinations thereof). In further embodiments, the molecular ratio of sorbed CO₂ to sorbed hydrocarbons in the porous carbon materials is greater than about 2. In additional embodiments, the molecular ratio of sorbed CO₂ to sorbed hydrocarbons in the porous carbon materials ranges from about 2 to about 3. In additional embodiments, the molecular ratio of sorbed CO₂ to sorbed hydrocarbons in the porous carbon materials is about 2.6.

In more specific embodiments, the sorption of CO₂ to porous carbon materials occurs selectively over the CH₄ in the environment. In further embodiments, the molecular ratio of sorbed CO₂ to sorbed CH₄ (n_{CO2}/n_{CH4}) in the porous carbon materials is greater than about 2. In additional embodiments, n_{CO2}/n_{CH4} in the porous carbon materials ranges from about 2 to about 3. In more specific embodiments, n_{CO2}/n_{CH4} in the porous carbon materials is about 2.6.

In some embodiments, sorption of CO₂ to porous carbon materials occurs selectively through poly(CO₂) formation within the pores of the porous carbon materials. Without being bound by theory, it is envisioned that poly(CO₂) formation within the pores of the porous carbon materials can displace other gases associated with the porous carbon materials, including any physisorbed gases and hydrocarbons (e.g., methane, propane, and butane). Without being bound by further theory, it is also envisioned that the displacement of other gases from the porous carbon materials creates a continual CO₂ selectivity that far exceeds various CO₂ selectively ranges, including the CO₂ selectivity ranges noted above.

In some embodiments, the covalent bond nature of poly(CO₂) within the pores of the porous carbon materials can be 100 times stronger than that of other physisorbed entities, including physisorbed gases within the pores of the porous carbon materials. Therefore, such strong covalent bonds can contribute to the displacement of the physisorbed gases (e.g., methane, propane and butane).

Release of Captured CO₂

In some embodiments, the methods of the present disclosure also include a step of releasing captured CO₂ from porous carbon materials. Various methods may be utilized to release CO₂ from porous carbon materials. For instance, in some embodiments, the releasing occurs by decreasing the pressure of the environment. In some embodiments, the pressure of the environment is reduced to atmospheric pressure or below atmospheric pressure. In some embodiments, the releasing occurs by placing the porous carbon material in a second environment that has a lower pressure than the environment where CO₂ capture occurred. In some embodiments, the second environment may be at or below atmospheric pressure. In some embodiments, the releasing occurs spontaneously as the environmental pressure decreases.

The release of captured CO₂ from porous carbon materials can occur at various pressures. For instance, in some embodiments, the release occurs at or below atmospheric pressure. In some embodiments, the release occurs at total pressures ranging from about 0 bar to about 100 bar. In some embodiments, the release occurs at total pressures ranging from about 0.1 bar to about 50 bar. In some embodiments, the release occurs at total pressures ranging from about 0.1 bar to about 30 bar. In some embodiments, the release occurs at total pressures ranging from about 0.1 bar to about 10 bar.

Without being bound by theory, it is envisioned that the release of captured CO₂ from porous carbon materials can occur by various mechanisms. For instance, in some embodiments, the release of captured CO₂ can occur through a depolymerization of the formed poly(CO₂) within the pores of the porous carbon materials. In some embodiments, the depolymerization can be facilitated by a decrease in environmental pressure.

The release of captured CO₂ from porous carbon materials can also occur at various temperatures. In some embodiments, the release occurs at ambient temperature. In some embodiments, the release occurs at the same temperature at which CO₂ sorption occurred. In some embodiments, the releasing occurs without heating the porous carbon materials. Therefore, in some embodiments, a temperature swing is not required to release captured CO₂ from porous carbon materials.

In some embodiments, the release occurs at temperatures ranging from about 30° C. to about 200° C. In some embodiments, the release is facilitated by also lowering the pressure.

In some embodiments, heat for release of CO₂ from porous carbon materials can be supplied from various sources. For instance, in some embodiments, the heat for the release of CO₂ from a porous carbon material-containing vessel can be provided by an adjacent vessel whose heat is being generated during a CO₂ sorption step.

Disposal of the Released CO₂

In some embodiments, the methods of the present disclosure also include a step of disposing the released CO₂. For instance, in some embodiments, the released CO₂ can be off-loaded into a container. In some embodiments, the released CO₂ can be pumped downhole for long-term storage. In some embodiments, the released CO₂ can be vented to the atmosphere. Additional methods by which to dispose the released CO₂ can also be envisioned.

Reuse of the Porous Carbon Material

In some embodiments, the methods of the present disclosure also include a step of reusing the porous carbon materials after CO₂ release to capture more CO₂ from an environment. In some embodiments, the porous carbon materials of the present disclosure may be reused over 100 times without substantially affecting their CO₂ sorption capacities. In some embodiments, the porous carbon materials of the present disclosure may be reused over 1000 times without substantially affecting their CO₂ sorption capacities. In some embodiments, the porous carbon materials of the present disclosure may be reused over 10,000 times without substantially affecting their CO₂ sorption capacities.

In some embodiments, the porous carbon materials of the present disclosure may retain 100% of their CO₂ sorption capacities after being used multiple times (e.g., 100 times, 1,000 times or 10,000 times). In some embodiments, the porous carbon materials of the present disclosure may retain at least 98% of their CO₂ sorption capacities after being used multiple times (e.g., 100 times, 1,000 times or 10,000 times). In some embodiments, the porous carbon materials of the present disclosure may retain at least 95% of their CO₂ sorption capacities after being used multiple times (e.g., 100 times, 1,000 times or 10,000 times). In some embodiments, the porous carbon materials of the present disclosure may retain at least 90% of their CO₂ sorption capacities after being used multiple times (e.g., 100 times, 1,000 times or 10,000 times). In some embodiments, the porous carbon materials of the present disclosure may retain at least 80% of their CO₂ sorption capacities after being used multiple times (e.g., 100 times, 1,000 times or 10,000 times).

Porous Carbon Materials

The methods of the present disclosure can utilize various types of porous carbon materials for CO₂ capture. Further embodiments of the present disclosure pertain to such porous carbon materials. In general, the porous carbon materials of the present disclosure include a plurality of pores and a plurality of nucleophilic moieties. As set forth in more detail herein, various porous carbon materials with various porosities and nucleophilic moieties may be utilized. Furthermore, the porous carbon materials of the present disclosure may have various surface areas, pore diameters, pore volumes, densities, and CO₂ sorption capacities.

Carbon Materials

The porous carbon materials of the present disclosure may be derived from various carbon materials. For instance, in some embodiments, the porous carbon materials of the present disclosure may include, without limitation, nucleophilic polymers, polypeptides, proteins, waste materials, nitrogen-containing porous carbon materials, sulfur-containing porous carbon materials, metal-containing porous carbon materials, metal oxide-containing porous carbon materials, metal sulfide-containing porous carbon materials, phosphorus-containing porous carbon materials, and combinations thereof. In some embodiments, the porous carbon materials of the present disclosure may include whey proteins. In some embodiments, the porous carbon materials of the present disclosure may include rice proteins. In some embodiments, the porous carbon materials of the present disclosure may include food waste. In some embodiments, the porous carbon material is carbonized. In some embodiments, the porous carbon material is reduced. In some embodiments, the porous carbon material is reduced and carbonized.

In more specific embodiments, the porous carbon materials of the present disclosure include a nucleophilic polymer. In some embodiments, the nucleophilic polymer includes, without limitation, nitrogen-containing polymers, sulfur-containing polymers, polythiophene (PTH), polythiophene-methanol (also called 2-(hydroxymethyl)thiophene), polyacrylonitrile (PAN), polypyrrole, and combinations thereof. In some embodiments, the nucleophilic polymer is carbonized. In some embodiments, the nucleophilic polymer is reduced. In some embodiments, the nucleophilic polymer is reduced and carbonized. In some embodiments, the nucleophilic polymer is reduced with hydrogen (H₂) treatment.

In additional embodiments, the porous carbon materials of the present disclosure include nitrogen containing porous carbons. In some embodiments, the nitrogen groups in the nitrogen containing porous carbons include at least one of pyridinic nitrogen (N-6), pyrrolic nitrogen (N-5), nitrogen oxides, and combinations thereof. In more specific embodiments, the nitrogen groups in the nitrogen containing porous carbons include nitrogen oxides, such as N-oxides. In some embodiments, the nitrogen containing porous carbons may include a nitrogen containing polymer, such as polyacrylonitrile. In some embodiments, the nitrogen containing porous carbons include carbonized polyacrylontrile, such as reduced and carbonized polyacrylonitrile.

In some embodiments, the porous carbons of the present disclosure include sulfur containing porous carbons. In more specific embodiments, the sulfur containing porous carbons include a polythiophene, such as poly[(2-hydroxymethyl)thiophene]. In further embodiments, the porous carbons of the present disclosure include polymer-derived nitrogen containing porous carbons with primary amines, secondary amines, tertiary amines, or nitrogen oxides. In some embodiments, the porous carbons of the present disclosure include polymer-derived sulfur containing porous carbons with primary sulfur groups (e.g., thiol), secondary sulfur groups, or sulfur oxides.

The porous carbon materials of the present disclosure may be fabricated by various methods. For instance, in some embodiments where porous carbon materials include nucleophilic polymers, nucleophilic polymer precursors may be polymerized to form the porous carbon materials. In some embodiments, the nucleophilic polymer precursors may be polymerized through treatment with a base, such as potassium hydroxide (KOH), sodium hydroxide (NaOH) or lithium hydroxide (LiOH). In some embodiments, the formed nucleophilic polymer materials may also be carbonized. In some embodiments, the formed nucleophilic polymers may also be reduced. In some embodiments, the formed nucleophilic polymers may be carbonized and reduced.

Nucleophilic Moieties

The porous carbon materials of the present disclosure may contain various arrangements of nucleophilic moieties. In some embodiments, the nucleophilic moieties are part of the porous carbon material. For instance, in some embodiments, the nucleophilic moieties are embedded within the porous carbon materials. In some embodiments, the nucleophilic moieties are homogenously distributed throughout the porous carbon material framework. In some embodiments, the nucleophilic moieties are embedded within the plurality of the pores of the porous carbon materials.

The porous carbon materials of the present disclosure may also contain various types of nucleophilic moieties. For instance, in some embodiments, the nucleophilic moieties include, without limitation, primary nucleophiles, secondary nucleophiles, tertiary nucleophiles and combinations thereof. In more specific embodiments, the nucleophilic moieties include, without limitation, oxygen-containing moieties, sulfur-containing moieties, metal-containing moieties, nitrogen-containing moieties, metal oxide-containing moieties, metal sulfide-containing moieties, phosphorus-containing moieties, and combinations thereof.

In more specific embodiments, the nucleophilic moieties include phosphorus-containing moieties. In some embodiments, the phosphorus containing moieties include, without limitation, phosphines, phosphites, phosphine oxides, and combinations thereof.

In more specific embodiments, the nucleophilic moieties of the present disclosure may include metal-containing moieties, such as metal oxide-containing moieties or metal sulfide containing moieties. In some embodiments, the metal-containing moieties may include metal centers. In some embodiments, the metal-containing moieties may include, without limitation, iron oxide, iron sulfide, aluminum oxide, silicon oxide, titanium oxide, and combinations thereof. In more specific embodiments, the metal-containing moieties of the present disclosure include iron oxide. In more specific embodiments, the metal-containing moieties of the present disclosure include iron sulfide.

In additional embodiments, the nucleophilic moieties of the present disclosure include nitrogen-containing moieties. In some embodiments where the porous carbon materials include nitrogen containing porous carbons, the nitrogen-containing moieties include the nitrogen groups within the porous carbons. In some embodiments, the nitrogen-containing moieties include, without limitation, primary amines, secondary amines, tertiary amines, nitrogen oxides, and combinations thereof. In some embodiments, the nitrogen-containing moieties include secondary amines. In some embodiments, the nitrogen-containing moieties include at least one of pyridinic nitrogen (N-6), pyrrolic nitrogen (N-5), nitrogen oxides, and combinations thereof. In more specific embodiments, the nitrogen containing moieties include nitrogen oxides, such as N-oxides.

In further embodiments, the nucleophilic moieties of the present disclosure include sulfur-containing moieties. In some embodiments where the porous carbon materials include sulfur-containing porous carbons, the sulfur-containing moieties include the sulfur groups within the porous carbons. In some embodiments, the sulfur-containing moieties include, without limitation, primary sulfurs, secondary sulfurs, sulfur-oxides, and combinations thereof. In some embodiments, the sulfur-containing moieties include secondary sulfurs. In more specific embodiments, the sulfur-containing moieties include thiophene groups. In some embodiments, the thiophene groups include thiophenic sulfur atoms that are incorporated into the porous carbon material framework through the formation of C—S—C bonds.

Surface Areas

The porous carbon materials of the present disclosure may have various surface areas. For instance, in some embodiments, the porous carbon materials of the present disclosure have surface areas that range from about 1,000 m²/g to about 3,000 m²/g. In some embodiments, the porous carbon materials of the present disclosure have surface areas that range from about 1,000 m²/g to about 2,000 m²/g. In some embodiments, the porous carbon materials of the present disclosure have surface areas that range from about 1,400 m²/g to about 2,500 m²/g. In more specific embodiments, the porous carbon materials of the present disclosure have surface areas that include at least one of 1450 m² g⁻¹, 1,500 m²/g, 1,700 m²/g, 1,900 m²/g, or 2500 m² g⁻¹.

Porosities

The porous carbon materials of the present disclosure may have various porosities. For instance, in some embodiments, the pores in the porous carbon materials include diameters between about 1 nanometer to about 5 micrometers. In some embodiments, the pores include macropores with diameters of at least about 50 nm. In some embodiments, the pores include macropores with diameters between about 50 nanometers to about 3 micrometers. In some embodiments, the pores include macropores with diameters between about 500 nanometers to about 2 micrometers. In some embodiments, the pores include mesopores with diameters of less than about 50 nm. In some embodiments, the pores include micropores with diameters of less than about 2 nm. In some embodiments, the pores include diameters that range from about 5 nm to about 100 nm.

The pores of the porous carbon materials of the present disclosure may also have various volumes. For instance, in some embodiments, the pores in the porous carbon materials have volumes ranging from about 1 cm³/g to about 10 cm³/g. In some embodiments, the pores in the porous carbon materials have volumes ranging from about 1 cm³/g to about 5 cm³/g. In some embodiments, the pores in the porous carbon materials have volumes ranging from about 1 cm³/g to about 3 cm³/g. In more specific embodiments, the plurality of pores in the porous carbon materials have volumes of about 1.5 cm³/g or about 1.43 cm³/g.

Densities

The porous carbon materials of the present disclosure may also have various densities. For instance, in some embodiments, the porous carbon materials of the present disclosure have densities that range from about 0.3 g/cm³ to about 10 g/cm³. In some embodiments, the porous carbon materials of the present disclosure have densities that range from about 0.3 g/cm³ to about 4 g/cm³. In some embodiments, the porous carbon materials of the present disclosure have densities that range from about 1 g/cm³ to about 3 g/cm³. In some embodiments, the porous carbon materials of the present disclosure have densities that range from about 1 g/cm³ to about 2 g/cm³. In some embodiments, the porous carbon materials of the present disclosure have densities that range from about 2 g/cm³ to about 3 g/cm³. In more specific embodiments, the porous carbon materials of the present disclosure have densities of 1.2 g/cm³, 2 g/cm³, 2.1 g/cm³, 2.20 g/cm³, 2.21 g/cm³, or 2.5 g/cm³.

CO₂ Sorption Capacities

The porous carbon materials of the present disclosure may also have various sorption capacities. For instance, in some embodiments, the porous carbon materials of the present disclosure have a CO₂ sorption capacity that ranges from about 10% to about 200% of the porous carbon material weight. In some embodiments, the porous carbon materials of the present disclosure have a CO₂ sorption capacity of about 50% to about 180% of the porous carbon material weight. In some embodiments, the porous carbon materials of the present disclosure have a CO₂ sorption capacity of about 55% to about 90% of the porous carbon material weight. In some embodiments, the porous carbon materials of the present disclosure have a CO₂ sorption capacity of about 55% to about 85% of the porous carbon material weight. In more specific embodiments, the porous carbon materials of the present disclosure have a CO₂ sorption capacity of about 58% or about 82% of the porous carbon material weight.

In further embodiments, the porous carbon materials of the present disclosure have a CO₂ sorption capacity of about 1 g to about 2 g of porous carbon material per 1 g of CO₂. In more specific embodiments, the porous carbon materials of the present disclosure have a CO₂ sorption capacity of about 1.5 g of porous carbon material weight per 1 g of CO₂.

Physical States

The porous carbon materials of the present disclosure may be in various states. For instance, in some embodiments, the porous carbon materials of the present disclosure may be in a solid state. In some embodiments, the porous carbon materials of the present disclosure may be in a gaseous state. In some embodiments, the porous carbon materials of the present disclosure may be in a liquid state.

Advantages

The CO₂ capture methods and the porous carbon materials of the present disclosure provide numerous advantages over prior CO₂ sorbents. In particular, the porous carbon materials of the present disclosure provide significantly higher CO₂ sorption capacities than traditional CO₂ sorbents. For instance, as set forth in the Examples herein, the CO₂ sorption capacities of the porous carbon materials can be nearly 3-5 times higher than that found in zeolite 5A, and 2-3 times higher than that found in ZIF-8.

Furthermore, unlike traditional CO₂ sorbents, the porous carbon materials of the present disclosure can selectively capture and release CO₂ at ambient temperature without requiring a temperature swing. For instance, unlike traditional CO₂ sorbents that require substantial heating for regeneration, the porous carbon materials of the present disclosure can be spontaneously regenerated through pressure swings. As such, the porous carbon materials of the present disclosure can avoid substantial thermal insults and be used effectively over successive cycles without losing their original CO₂ sorption capacities. Moreover, due to the availability and affordability of the starting materials, the porous carbon materials of the present disclosure can be made in a facile and economical manner in bulk quantities, unlike many metal-oxide framework (MOF) materials.

As such, the CO₂ capture methods and the porous carbon materials of the present disclosure can find numerous applications. For instance, in some embodiments, the CO₂ capture methods and the porous carbon materials of the present disclosure can be utilized for the capture of CO₂ from subsurface oil and gas fields. In more specific embodiments, the process may take advantage of differential pressures commonly found in natural gas collection and processing streams as a driving force during CO₂ capture and poly(CO₂) formation. For instance, in some embodiments, the methods of the present disclosure may utilize a natural gas-well pressure (e.g., a natural gas well pressure of 200 to 300 bar) as a driving force during CO₂ capture and poly(CO2) formation. Thereafter, by lowering the pressure back to ambient conditions after CO₂ uptake, the poly(CO₂) is then depolymerized, where it can be off-loaded or pumped back downhole into the structures that had held it for geological timeframes. Moreover, the CO₂ capture methods and the porous carbon materials of the present disclosure can allow for the capture and reinjection of CO₂ at the natural gas sites, thereby leading to greatly reduced CO₂ emissions from natural gas streams.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### Capture of CO₂ by Sulfur- and Nitrogen-Containing Porous Carbons

In this Example, nucleophilic porous carbons are synthesized from simple and inexpensive carbon-sulfur and carbon-nitrogen precursors. Infrared, Raman and ¹³C nuclear magnetic resonance signatures substantiate CO₂ fixation by polymerization in the carbon channels to form poly(CO₂) under much lower pressures than previously required. This growing chemisorbed sulfur- or nitrogen-atom-initiated poly(CO₂) chain further displaces physisorbed hydrocarbon, providing a continuous CO₂ selectivity. Once returned to ambient conditions, the poly(CO₂) spontaneously depolymerizes, leading to a sorbent that can be easily regenerated without the thermal energy input that is required for traditional sorbents.

More specifically, Applicants show in this Example that the new carbon materials can be used to separate CO₂ from various environments (e.g., natural gas), where 0.82 g of CO₂ per g of sorbent (82 wt %) can be captured at 30 bar. A mechanism is described where CO₂ is polymerized in the channels of the porous carbon materials, as initiated by the sulfur or nitrogen atoms that are part of the carbon framework. Moreover, no temperature swing is needed. The reaction proceeds at ambient temperature. Without being bound by theory, it is envisioned that heat transfer between cylinders during the exothermic sorption and endothermic desorption can provide the requisite thermodynamic exchanges.

In some instances, the process can use the natural gas-well pressure of 200 to 300 bar as a driving force during the polymerization. By lowering the pressure back to ambient conditions after CO₂ uptake, the poly(CO₂) is then depolymerized, where it can be off-loaded or pumped back downhole into the structures that had held it for geological timeframes.

### EXAMPLE 1.1

### Synthesis and Characterization of Porous Carbons

Sulfur- and nitrogen-containing porous carbons (SPC and NPC, respectively) were prepared by treating bulk precursor polymers with potassium hydroxide (KOH) at 600° C., as described previously (Carbon 44, 2816-2821 (2006); Carbon 50, 5543-5553 (2012)).

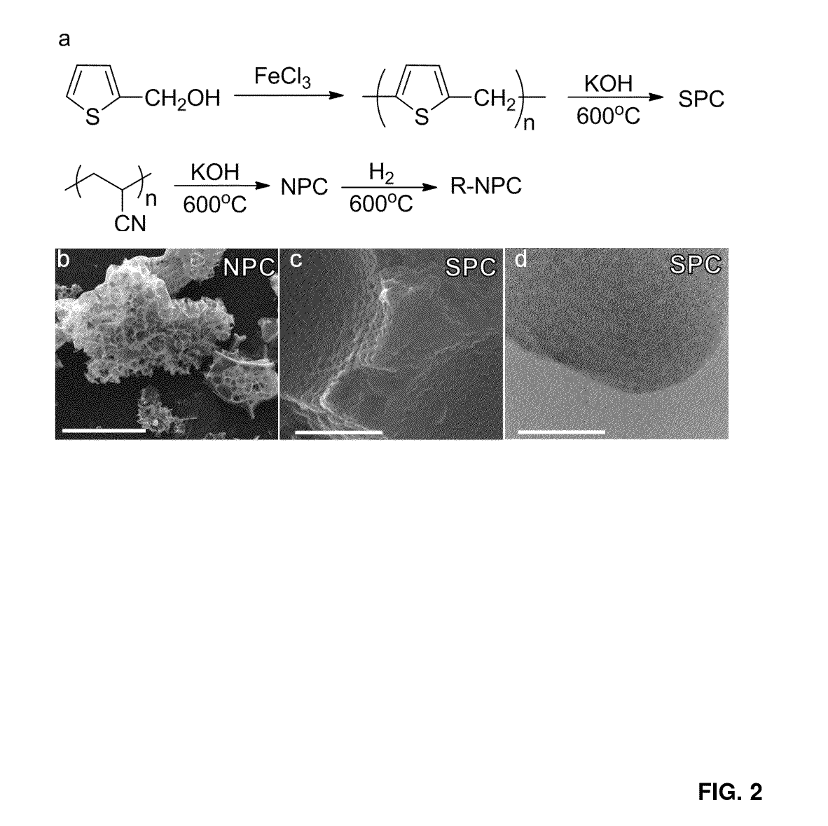

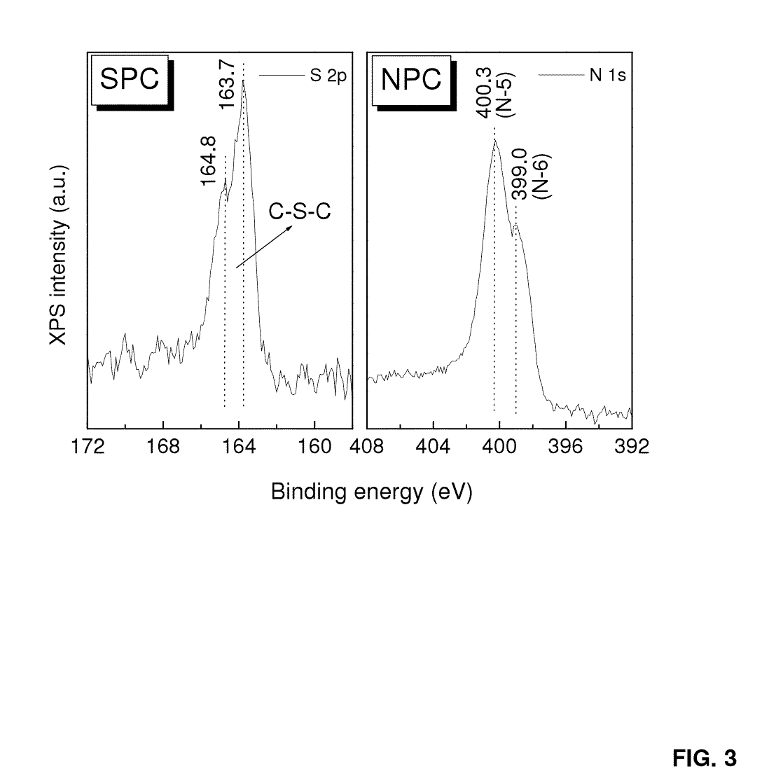

As shown in FIG. 2A, the resulting products were solid porous carbon materials with homogeneously distributed sulfur or nitrogen atoms incorporated into the carbon framework. They exhibited pores and channel structures as well as high surface areas of 2500 and 1490 m² g⁻¹ (N₂, Brunauer-Emmett-Teller) for the SPC and the NPC, respectively, with pore volumes of 1.01 cm³ g⁻¹ and 1.40 cm³ g⁻¹, respectively. The scanning electron microscopy (SEM) and transmission electron microscopy (TEM) images are shown in FIGS. 2B-D, and the X-ray photoelectron spectroscopy (XPS) analyses are shown in FIG. 3.

### EXAMPLE 1.2

### CO₂ Uptake Measurements

For CO₂ uptake measurements, samples were analyzed using volumetric analysis instruments at Rice University and at the National Institute of Standards and Technology (NIST). The measurements were further confirmed with gravimetric measurements.

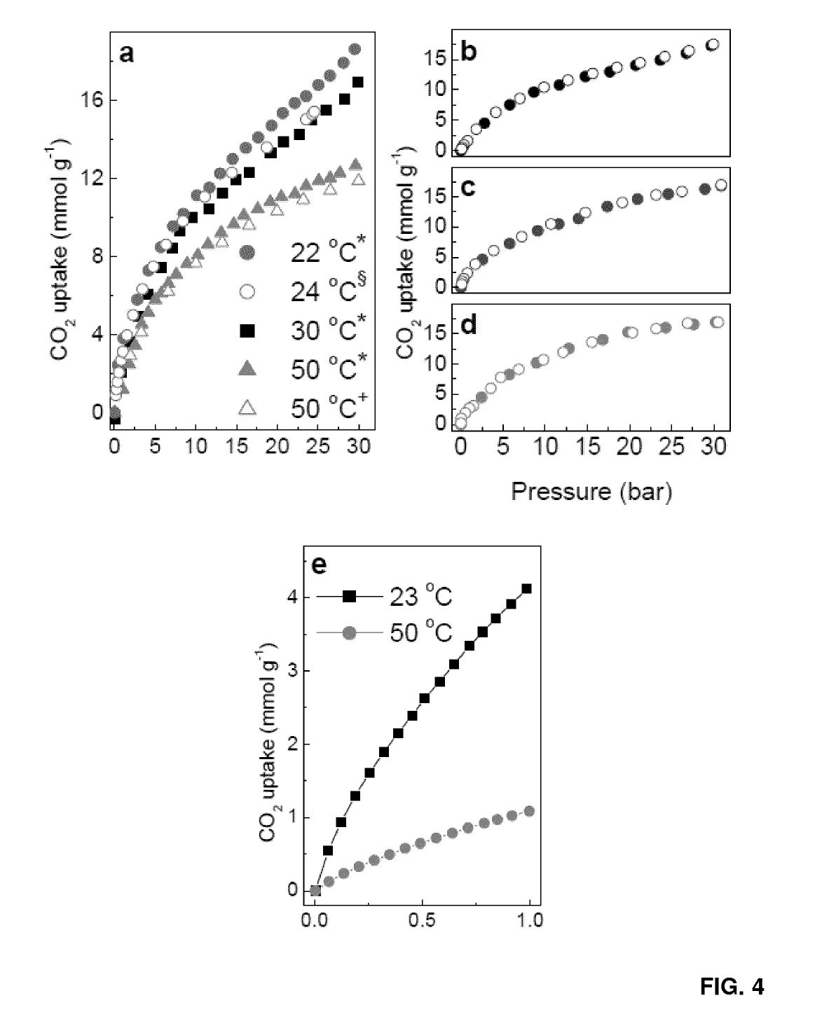

FIG. 4 shows the pressure-dependent CO₂ excess uptake for the SPC sorbent at different temperatures peaking at 18.6 mmol CO₂ g⁻¹ of sorbent (82 wt %) when at 22° C. and 30 bar. The sorption results measured by volumetric and gravimetric analyses were comparable, as were those measurements on the two volumetric instruments.

Applicants chose 30 bar as the upper pressure limit in experiments because a 300 bar well-head pressure at 10 mol % CO₂ concentration would have a CO₂ partial pressure of 30 bar. FIGS. 4B-D show three consecutive CO₂ sorption-desorption cycles on SPC over a pressure range from 0 to 30 bar, which indicates that the SPC could be regenerated using a pressure swing process while retaining its original CO₂ sorption capacity.

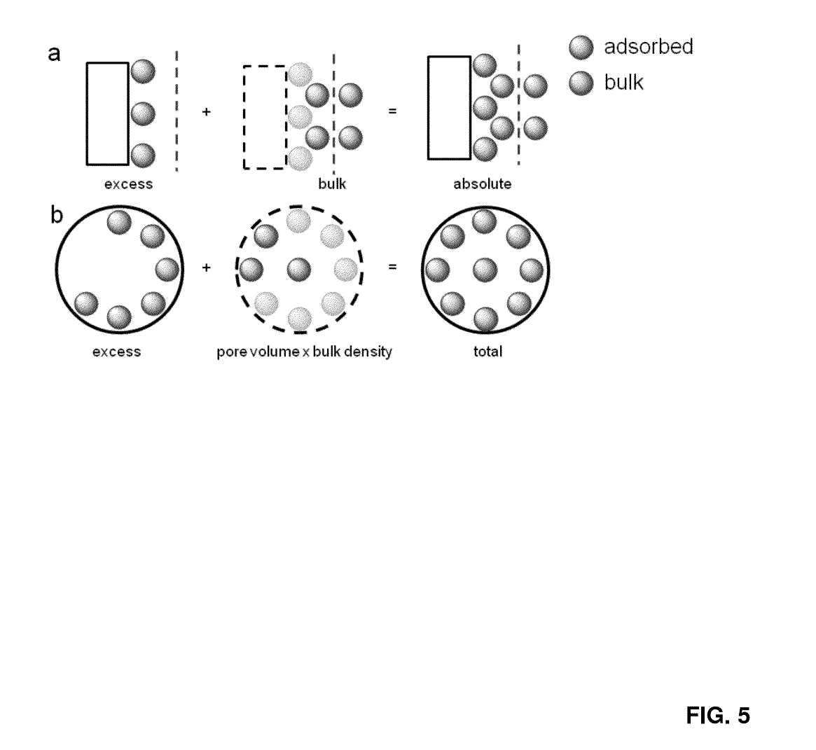

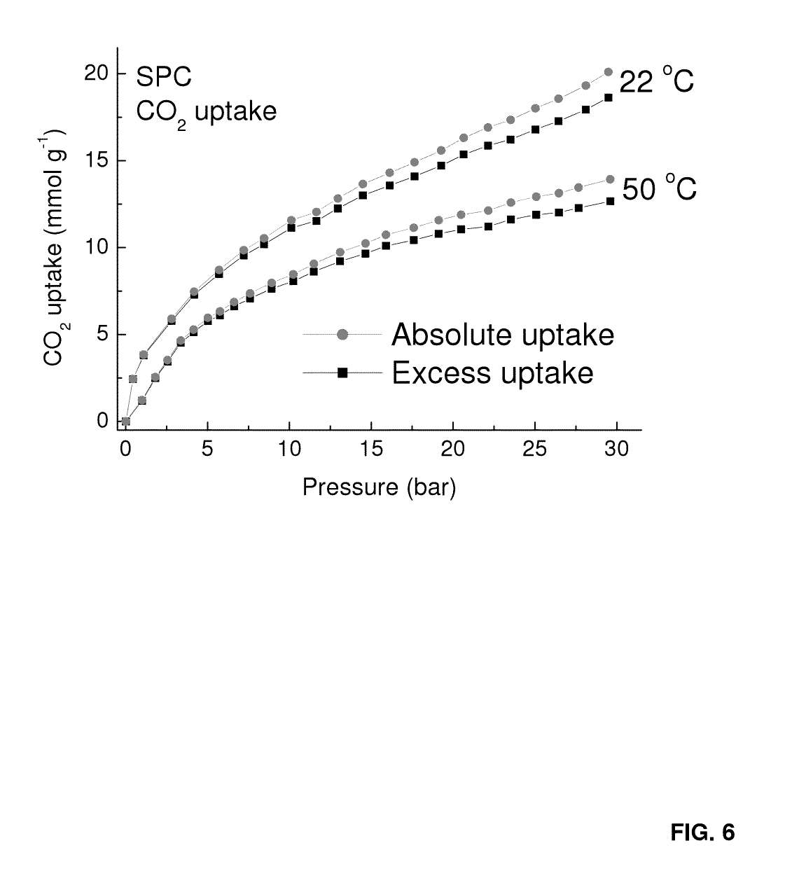

In the case of microporous materials with negligible external surface area, total uptake is often used as an approximation for absolute uptake, and the two values here are within 10% of each other. For example, the absolute CO₂ uptake of the SPC was 20.1 and 13.9 mmol g⁻¹ under 30 bar at 22 and 50° C., respectively. See FIGS. 5-6 and Example 1.8.

Similarly, although absolute adsorption isotherms can be used to determine the heat of sorption, excess adsorption isotherms are more often used to calculate the heat of CO₂ sorption (Q_{CO2}) before the critical point of the gas. Thus, the excess CO₂ sorption isotherms measured at two different temperatures, 23° C. and 50° C. (FIG. 4E), were input into the Clausius-Clapeyron equation. At lower surface coverage (≦1 bar), which could be expected to be more indicative of the sorbate-sorbent interaction, the SPC exhibits a heat of CO₂ sorption of 57.8 kJ mol⁻¹. Likewise, the maximum Q_{CO2} values for nucleophile-free porous materials, such as activated carbon, Zeolite 5A and zeolitic imidazolate framework (ZIF-8, a class of the MOF) were measured to be 28.4, and 31.2, 25.6 kJ mol⁻¹, respectively, at low surface coverage (see Example 1.9). Based on this data, the SPC possesses the highest CO₂ sorption enthalpy among these complementary sorbents measured at low surface coverage.

In order to better assess the sorption mechanism during the CO₂ uptake, attenuated total reflectance infrared spectroscopy (ATR-IR) was used to characterize the properties of the sorbents before and after the CO₂ uptake. A sample vial with ˜100 mg of the SPC was loaded into a 0.8 L stainless steel autoclave equipped with a pressure gauge and valves. Before the autoclave was sealed, the chamber was flushed with CO₂ (99.99%) to remove residual air, and the system was pressurized to 10 bar (line pressure limitation). The sorbent was therefore isobarically exposed to CO₂ in the closed system at 23° C. After 15 min, the system was vented to nitrogen at ambient pressure and the sorbent vial was immediately removed from the chamber and the sorbent underwent ATR-IR and Raman analyses in air.

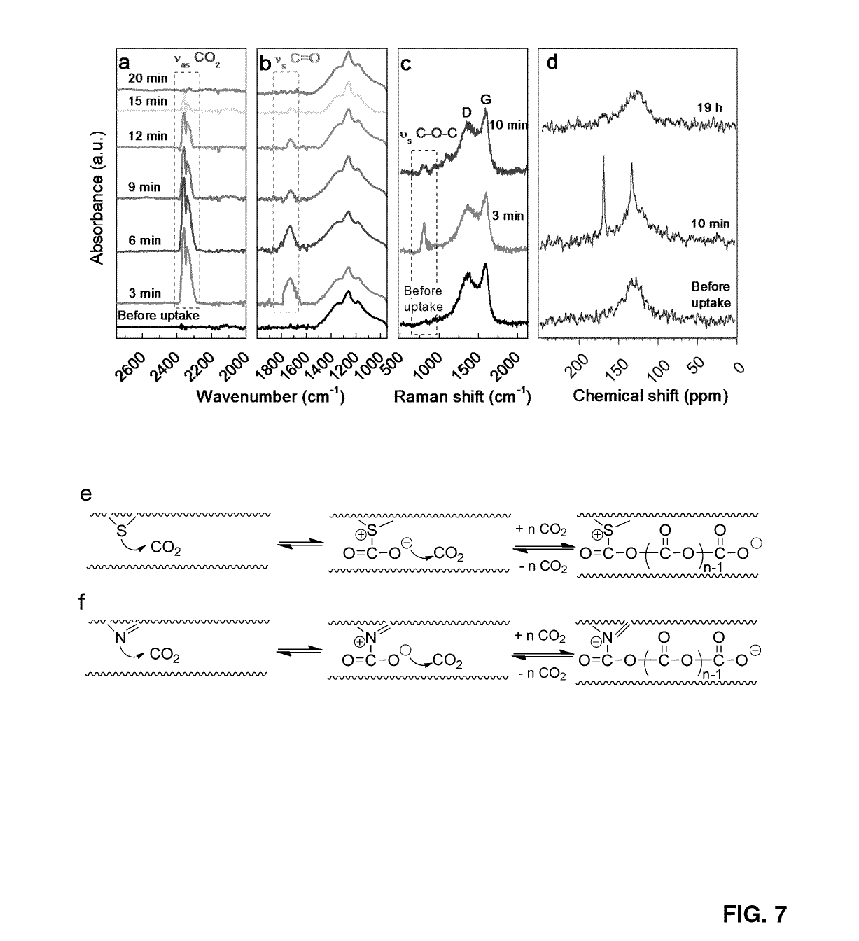

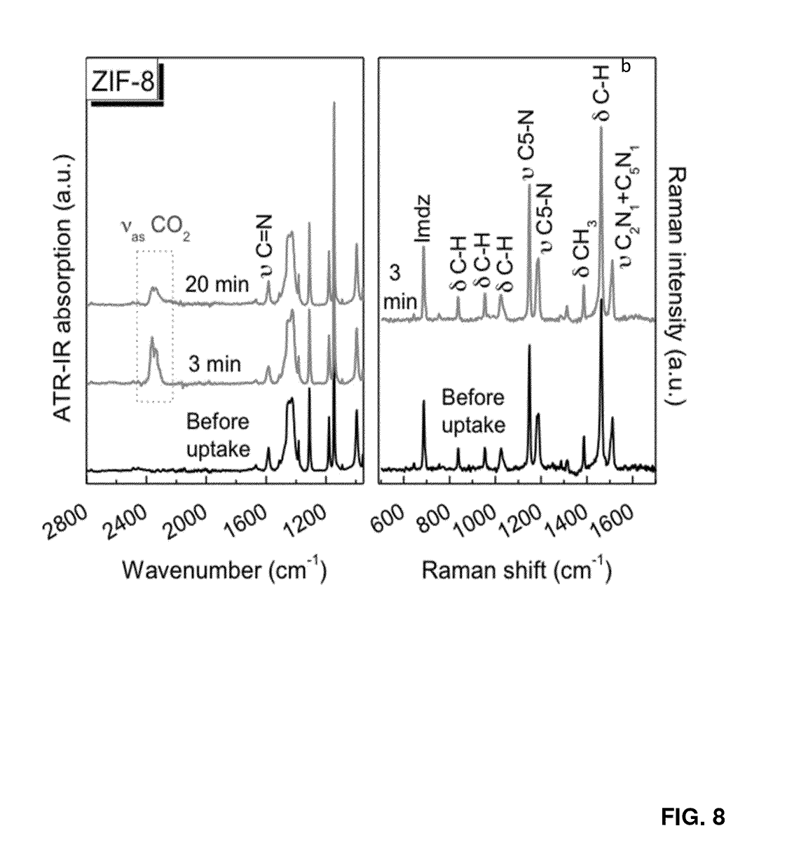

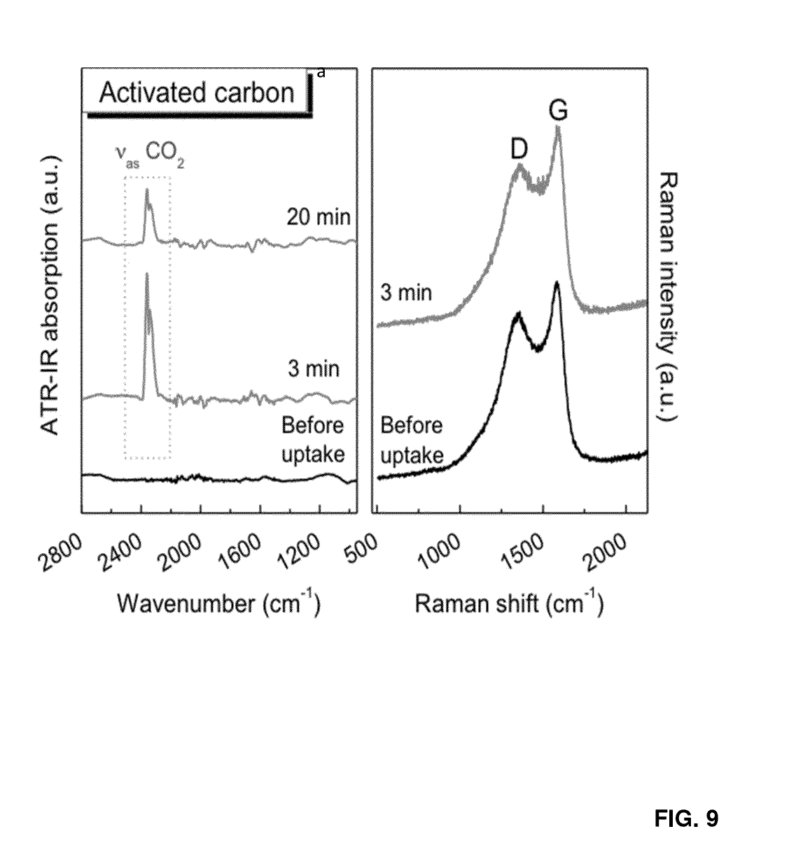

FIGS. 7A-B show the ATR-IR spectra of the SPC before (black line) and after exposure to 10 bar of CO₂, followed by ambient conditions for the indicated times. The two regions that appear in the ATR-IR spectra (outlined by the dashed-line boxes) after the CO₂ sorption are of interest. The first IR peak, located at 2345 cm⁻¹, is assigned to the anti-symmetric CO₂ stretch, confirming that CO₂ was physisorbed and evolving from the SPC sorbent. The other IR band, centered at 1730 cm⁻¹, is attributed to the C═O symmetric stretch from the poly(CO₂) on the SPC. Interestingly, this carbonyl peak is only observed with the porous heteroatom-doped carbon, such as the SPC and NPC. Other porous sorbents without nucleophilic species, such as ZIF-8 and activated carbon, only showed the physisorbed or evolving CO₂ peak (˜2345 cm⁻¹) (FIGS. 8-9). Once the CO₂-filled SPC returned to ambient pressure, the key IR peaks attenuated over time and disappeared after 20 min. Based on this data, the ATR-IR study confirmed the poly(CO₂) formation. Raman spectroscopy was further used to probe individual chemical bond vibrations, as shown in FIG. 7C. The carbonaceous graphitic G-band and defect-derived diamonoid D-band were at 1590 and 1350 cm⁻¹. The peak at 798 cm⁻¹ can be attributed to the symmetric stretch of the C—O—C bonds, which was not observed for the other nucleophile-free porous materials, suggesting that the poly(CO₂), with the —(O—C(═O))ₙ— moiety, was formed.

Without being bound by theory, it is envisioned that the monothiocarbonate and carbamate anions within the channels of the SPC and NPC, respectively, were the likely initiation points for the CO₂ polymerization since no poly(CO₂) was seen in activated carbon (FIG. 9). Furthermore, ¹³C NMR also confirms the presence of the poly(CO₂) formation. The sorbent gives a broad signal characteristic of aromatic carbon (FIG. 7D, bottom).

After exposure to CO₂, a relatively sharp signal on top of the broad sorbent signal appears at 130.6 ppm, which can be assigned to the CO₂ that is evolving from the support. A sharp signal also appears at 166.5 ppm (FIG. 7D, middle) that is characteristic of the carbonyl resonance for poly(CO₂). Both of these signals are gone 19 h later (FIG. 7D, top). These assignments are further discussed in detail in Example 1.10.

Compared to secondary amine-based CO₂ sorbents where maximum capture efficiency is 0.5 mol CO₂ per mol N (2 RNH₂+CO₂→RNH₃⁺⁻O₂CNHR), the SPC and NPC demonstrate a unique mechanism during the CO₂ uptake process resulting in their remarkably higher CO₂ capacities versus S or N content (8.1 atomic % of S and 6.2 atomic % of N in the SPC and NPC, respectively, by XPS analysis).

FIGS. 7E-F show illustrations of the aforementioned CO₂-fixation by polymerization. Dimeric CO₂ uptake has been crystallographically observed in metal complexes, and polymeric CO₂ has been detected previously but only at extremely high pressures of ˜15,000 bar. The spectroscopic determination here confirms poly(CO₂) formation at much lower pressures than formerly observed.

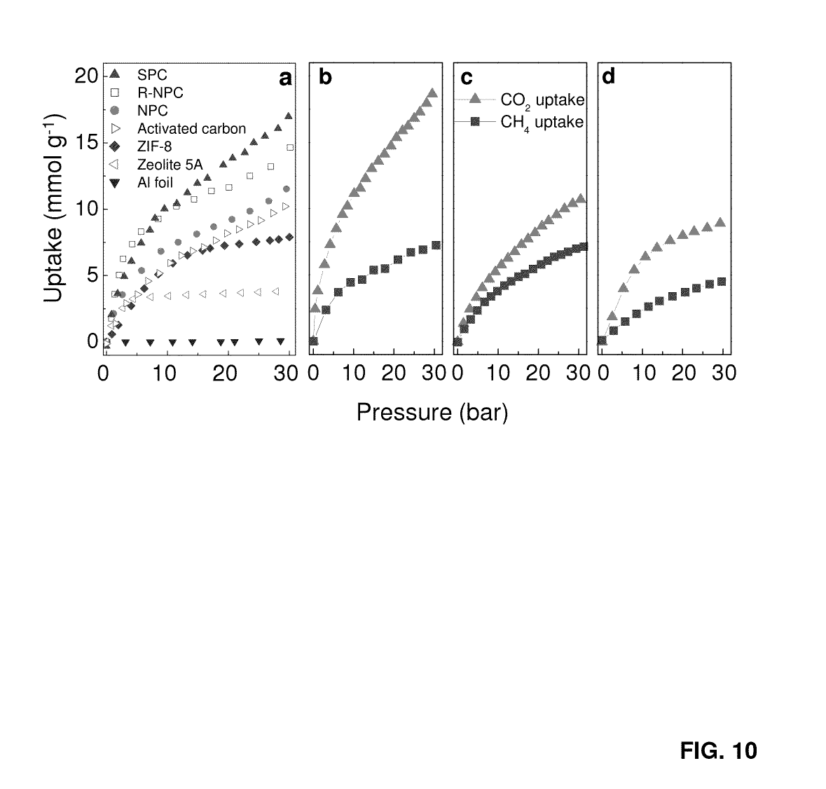

A series of porous materials with and without the nucleophilic heteroatoms were tested to compare their CO₂ capture performance up to 30 bar at 30° C. (FIG. 10A). The SPC had the highest CO₂ capacity. The NPC, activated carbon, zeolite 5A and ZIF-8 had lower capacities. Although NPC had lower CO₂ capacity than SPC, its uptake performance could be improved by 21 wt % after H₂ reduction at 600° C., producing reduced-NPC (R-NPC) with secondary amine groups (FIG. 2A).

Even though the surface area of R-NPC (1450 m² g⁻¹) is only slightly greater than that of the activated carbon (1430 m² g⁻¹), the presence of the amine groups induces the formation of the poly(CO₂) under pressure, promoting the CO₂ sorption efficiency of the R-NPC. The pore volume of R-NPC is 1.43 cm³ g⁻¹.

Purification of natural gas from wells relies upon a highly CO₂-selective sorbent, especially in a CH₄-rich environment. Thus, CH₄ uptake experiments were carried out on three different types of porous materials, SPC, activated carbon and ZIF-8. FIGS. 10B-D compare CO₂ and CH₄ sorption over a pressure range from 0 to 30 bar at 23° C. In contrast to the CO₂ sorption, the CH₄ isotherms for these three sorbents reached equilibrium while the system pressure was approaching 30 bar. The order of the CH₄ uptake capacities was correlated to the surface area of the sorbents. Comparing these sorbents, the observed molecular ratio of sorbed CO₂ to CH₄ (n_{CO2}/n_{CH4}) for the SPC (2.6) was greater than that for the activated carbon (1.5) and ZIF-8 (1.9). In addition, the density of the SPC calculated using volumetric analysis is nearly 6-fold higher than in the ZIF-8 (2.21 vs. 0.35 g cm⁻³) and 3-fold higher than the zeolite 5A (2.21 vs. 0.67 g cm⁻³). The high CO₂ capacity and high density observed for SPC greatly increase the volume efficiency, which would reduce the volume of the sorption material for a given CO₂ uptake production rate.

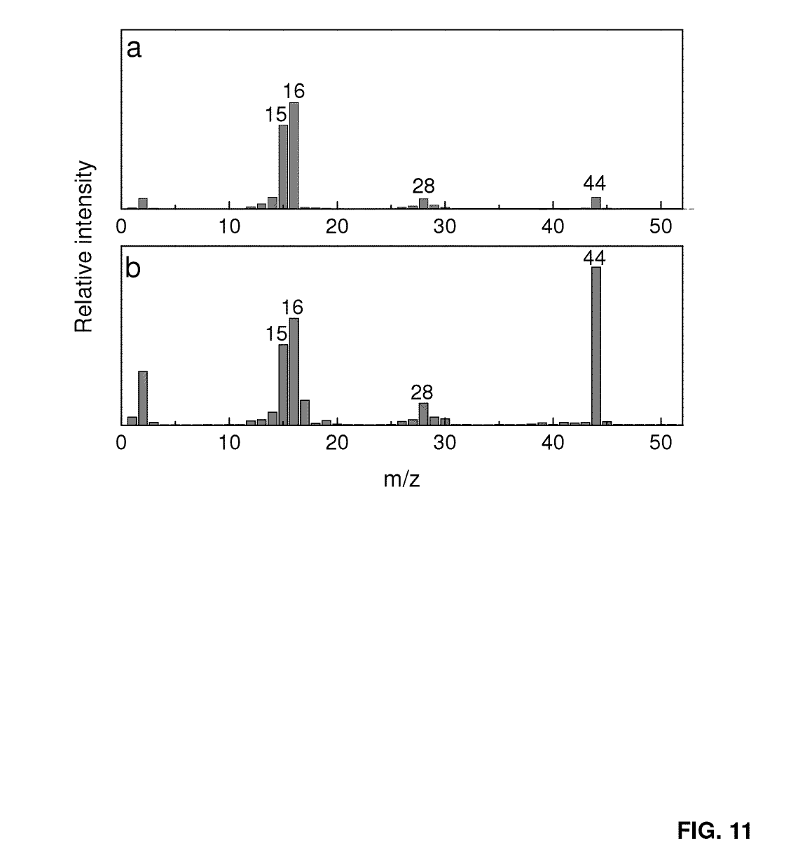

In order to mimic a gas well environment and further characterize the SPC's selectivity to CO₂, a premixed gas (85 mol % CH₄, 10 mol % CO₂, 3 mol % C₂H₆ and 2 mol % C₃H₈) was used with quadrupole mass spectrometry (MS) detection. The MS inlet was connected to the gas uptake system so that it could monitor the gas effluent from the SPC throughout the sorption-desorption experiment. FIG. 11 shows the mass spectrum recorded during the sorption process. The peaks at 15 and 16 amu correspond to fragment and molecular ions from CH₄, while the peaks at 28 and 44 amu are from CO₂ in the premixed gas. Other minor peaks can be assigned to fragment ions from C₂H₆ and C₃H₈. Although the peak at 44 amu can also come from C₃H₈ ions, the contribution is negligible because of the lower C₃H₈ concentration in the mixed gas, and it is distinguishable by the fragmentation ratios in the MS [C₃H₈: m/z=29 (100), 44 (30); CO₂: m/z=44(100), 28(11)]. The observed intensity ratio of two peaks at 16 and 44 amu (I₁₆/I₄₄=9.1) indicates the abundance of CH₄ vs. CO₂ during the sorption and also reflects the relative amount of CH₄ and CO₂ in the premixed gas. Once the sorption reached equilibrium under 30 bar, the desorption process was induced by slowly venting into the MS system. The I₁₆/I₄₄ ratio reduced to ˜0.7. The SPC has been shown to have 2.6-fold higher CO₂ than CH₄ affinity at 30 bar when using pure CO₂ and CH₄ as feed gases (FIG. 10B).

If the binding energy of CH₄ and CO₂ were assumed to be similar, and the partial pressure of CH₄ vs. CO₂ in the premixed gas is considered (P_{CH4}/P_{CO2}=8.5), then it is envisioned that the number of sorbed CH₄ should be ˜3.3-times more than that of the sorbed CO₂. It is also envisioned that CO₂-selective materials have selective sites and once the CO₂ occupies those sites, the selectivity significantly decreases and the materials behave as physisorbents with lower selectivities at larger pressures. On the contrary, here the SPC demonstrates much higher CO₂ selectivity than expected since the chemisorbed sulfur-initiated poly(CO₂) chain displaces physisorbed gas.

Under the mechanism described here for CO₂ polymerization in the channels of inexpensive nucleophilic porous carbons, these new materials have continuous selectivity toward CO₂, limited only by the available pore space and pressure.

### EXAMPLE 1.3

### Instrumentations (Rice University)

An automated Sieverts instrument (Setaram PCTPro) was adopted to measure gas (CO₂, CH₄ or premixed gas) sorption properties of materials. Typically, a ˜70 mg of sorbent was packed into a ˜1.3 mL of stainless steel sample cell. The sample was pretreated under vacuum (˜3 mm Hg) at 130° C. for 6 h and the sample volume was further determined by helium before the uptake experiment. At each step of the measurement, testing gas was expanded from the reference reservoir into the sample cell until the system pressure reached equilibrium. A quadrupole mass spectrometer (Setaram RGA200) was connected to the Sieverts instrument so that it could monitor the gas effluent from the sorbent throughout the entire sorption-desorption experiment. With the assistance of a hybrid turbomolecular drag pump, the background pressure of the MS can be controlled lower than 5×10⁻⁸ Torr. All material densities were determined using volumetric analysis on this same instrument.

XPS was performed using a PHI Quantera SXM Scanning X-ray Microprobe with a base pressure of 5×10⁻⁹ Torr. Survey spectra were recorded in 0.5 eV step size and a pass energy of 140 eV. Elemental spectra were recorded in 0.1 eV step size and a pass energy of 26 eV. All spectra were standardized using C1s peak (284.5 eV) as a reference.

The ATR-IR experiment was conducted using a Fourier transform infrared spectrometer (Nicolet Nexus 670) equipped with an attenuated total reflectance system (Nicolet, Smart Golden Gate) and a MCT-A detector. Raman spectra were measured using a Renishaw in Via Raman Microscope with a 514 nm excitation argon laser.

Scanning electron microscope (SEM) images were taken at 15 KeV using a JEOL-6500F field emission microscope. High-resolution transmission electron microscope (TEM) images were obtained with a JEOL 2100F field emission gun TEM.

An automated BET surface analyzer (Quantachrome Autosorb-3b) was used for measurements of sorbents' surface areas and pore volumes based on N₂ adsorption-desorption. Typically, a ˜100 mg of sample was loaded into a quartz tube and pretreated at 130° C. under vacuum (˜5 mm Hg) in order to remove sorbates before the measurement.

MAS NMR spectra were recorded on a Bruker Avance III 4.7 T spectrometer with a standard MAS probe for 4 mm outer diameter rotors.

### EXAMPLE 1.4

### Volumetric CO₂ Sorption Experiments (NIST)

CO₂ sorption measurements were carried out on computer-controlled custom-built volumetric sorption equipment previously described in detail (J. Phys. Chem. C 111, 16131-16137 (2007)) with an estimated reproducibility within 0.5% and isotherm data error bar of less than 2% compared to other commercial instruments. An amount of ˜79 mg of sample was used for the experiments. Sample degassing, prior to the CO₂ sorption experiment, was done at 130° C. under vacuum for 12 h.

### EXAMPLE 1.5

### Gravimetric CO₂ Sorption Experiments

CO₂ sorption measurements were performed on a high pressure thermal gravimetric equipment (Model: TGA-HP50) from TA Instruments. An amount of ˜15 mg of sample was used for the experiments. Sample degassing, prior to CO₂ sorption experiment, was done at 130° C. under vacuum for 12 h.

### EXAMPLE 1.6

### Synthesis of S-Containing Porous Carbon (SPC)

Poly[(2-hydroxymethyl)thiophene] (PTh) (Sigma-Aldrich) was prepared using FeCl₃. Microporous Mesoporous Mater. 158, 318-323 (2012). In a typical synthesis, 2-thiophenemethanol (1.5 g, 13.1 mmol) in CH₃CN (10 mL) was slowly added under vigorous stirring to a slurry of FeCl₃ (14.5 g, 89.4 mmol) in CH₃CN (50 mL). The mixture was stirred at room temperature for 24 h. The polymer (PTh) was separated by filtration over a sintered glass funnel, washed with distilled water (˜1 L) and then with acetone (˜200 mL). The polymer was dried at 100° C. for 12 h to afford (1.21 g, 96% yield) of the desired compound.

The PTh was activated by grinding PTh (500 mg) with KOH (1 g, 17.8 mmol) with a mortar and pestle and then heated under Ar at 600° C. in a tube furnace for 1 h. The Ar flow rate was 500 sccm. After cooling, the activated sample was thoroughly washed 3× with 1.2 M HCl (1 L) and then with distilled water until the filtrate was pH 7. The SPC sample was dried in an oven at 100° C. to afford 240 mg of the black solid SPC. The BET surface area and pore volume were 2500 m² g⁻¹ and 1.01 cm³ g⁻¹, respectively.

### EXAMPLE 1.7

### Synthesis of N-Containing Porous Carbon (NPC)

Commercial polyacrylonitrile (PAN, 500 mg, average M_{w} 150,000, Sigma-Aldrich) powder and KOH (1500 mg, 26.8 mmol) were ground to a homogeneous mixture in a mortar. The mixture was subsequently carbonized by heating to 600° C. under Ar (500 sccm) in a tube furnace for 1 h. The carbonized material was washed 3× with 1.2 M HCl (1 L) and then with distilled water until the filtrate was pH 7. Finally, the carbon sample was dried in an oven at 100° C. to afford 340 mg of the solid black NPC.

To produce R-NPC, the activated material (270 mg) was further reduced by 10% H₂ (H₂:Ar=50:450 sccm) at 600° C. for 1 h to provide 255 mg of the final material. The BET surface area and pore volume were 1450 m² g⁻¹ and 1.43 cm³ g⁻¹, respectively.

### EXAMPLE 1.8

### Conversion of Excess Uptake to Absolute Uptake

Total uptake includes all gas molecules in the adsorbed state, which is the sum of the experimentally measured excess uptake and the bulk gas molecules within the pore volume (FIG. 5). For microporous materials with negligible external surface area, the total uptake is often used as an approximation for absolute uptake and could be represented in the following equation:

Nₜₒₜₐₗ≈N_{abs.}=N_{ex.}+Vₚ·ρ_{bulk}(P,T)

In the above equation, Vₚ is the pore volume of porous material and ρ_{bulk} is the density of gas in the bulk phase at given pressure and temperature. In the case of SPC, the pore volume was determined to be 1.01 cm³ g⁻¹ by N₂ adsorption isotherm at 77 K (BET analysis). The CO₂ density changes from 0.00180 to 0.06537 g cm⁻³ in the pressure range between 1 and 30 bar at 22° C. and 0.00164 to 0.05603 g cm⁻³ at 50° C.

### EXAMPLE 1.9

### Determination of the Heat of CO₂ Sorption (Q)

The Clausius-Clapeyron equation (Adsorption 175, 133-137 (1995)) was used to determine the heat of CO₂ sorption:

$${( \frac{\partial ln P}{\partial T} )}_{θ} = \frac{Q}{{RT}^{2}}$$

In the above equation, θ is the fraction of the adsorbed sites at a pressure P and temperature T, and R is the universal constant. The equation can be further derived as the following expression for transitions between a gas and a condense phase:

$$ln {P}_{2} - ln {P}_{1} = \frac{Q}{R} ( \frac{1}{{T}_{1}} - \frac{1}{{T}_{2}} )$$

Table 1 below compares the heat of CO₂ sorption to values in the literature.

TABLE 1
Heat of CO₂ sorption determined in
Example 1 versus literature values.

| | | Comparison with |
|---|---|---|
| | Q_{CO2} (kJ mol⁻¹) | reference |
| SPC | 57.8 | 59.0¹ |
| Activated carbon | 28.4 | 28.9² |
| Zeolite 5A | 31.2 | 33.7³ |
| ZIF-8 | 25.6 | 27.0⁴ |

Ref. ¹Carbon 50, 5543-5553 (2012).
Ref. ²J. Natural Gas Chem. 15, 223-229 (2006).
Ref. ³Handbook of Zeolite Science and Technology, Marcel Dekker, Inc. New York (2003).
Ref. ⁴AIChE J. 59, 2195-2206 (2013).

### EXAMPLE 1.10

### Evaluation of the ¹³C NMR Assignments

The three NMR spectra in FIG. 7D were obtained under identical conditions: 12 kHz MAS, 2.5-μs 90° ¹³C pulse, 41-ms FID, 10-s relaxation delay; 480 scans; and 50 Hz of line broadening applied to the FID.

Numerous MAS NMR investigations of CO₂ have reported a signal at 125±1 ppm, regardless of the physical environment for the CO₂ (e.g., free gas, physisorbed on various materials, in a metal organic framework, in a clathrate, dissolved in a glass, etc.) Accordingly, attributing the signal at 130.6 ppm to CO₂ physisorbed on the sorbent seems reasonable, although the reason for the additional deshielding may not be apparent. It is envisioned that this 5-ppm difference does not result from the use of different chemical shift references, as the various reports indicate that either the signal from Si(CH₃)₄ (TMS) serves as the chemical shift reference (0 ppm) or that the signal from a solid such as adamantane or glycine (this work) relative to TMS at 0 ppm serves as the chemical shift reference. Applicants note that the sorbent is somewhat conductive in that it has a noticeable effect on the tuning and matching of the ¹³C and ¹H channels of the NMR probe (relative to the tuning and matching for glycine). However, spinning is unaffected. Without being bound by theory, it is envisioned that the conductive nature of the sorbent results in the 5-ppm deshielding effect observed for physisorbed CO₂.

A chemical shift of 166.5 ppm is rational for poly(CO₂) in light of various reports of bicarbonate and carbonate species giving signals from 162 to 170 ppm relative to TMS or to [(CH₃)₃Si]₄Si, which is 3.5 ppm relative to TMS at 0 ppm. The carbonyl chemical shift of CH₃O—CO—O—CO—OCH₃ is extremely sensitive to its environment (the reported shift is 147.9 ppm as a neat liquid at 37° C. and 157 ppm in CDCl₃, both relative to TMS). Applicants are not aware of any reports of chemical shift data for poly(CO₂) and are hereby reporting the first such example of that chemical shift at 166.5 ppm when entrapped in this carbon matrix.

### EXAMPLE 2

### CO₂ Absorption Capacities of Different Carbon Materials

In this example, the CO₂ uptake capacities of SPC, R-NPC, rice protein, ZIF-8 and Zeolite 5A were compared. The CO₂ uptake measurements were conducted at 30° C. and 30 bar.

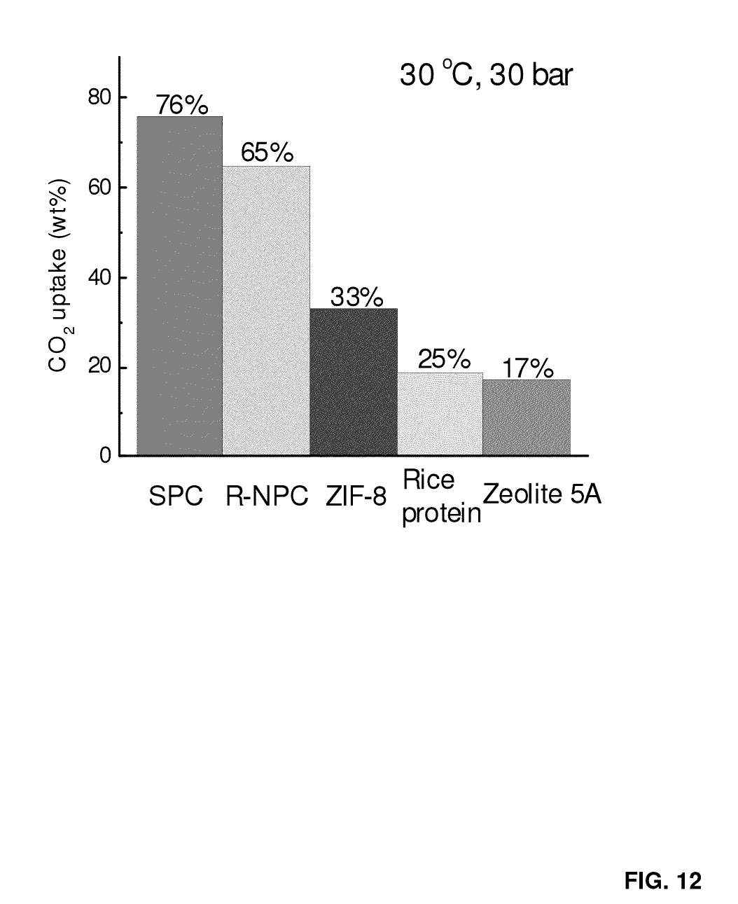

As shown in FIG. 12, the CO₂ uptake capacities of SPC and R-NPC were significantly higher than the CO₂ uptake capacities of ZIF-8, rice protein, and Zeolite 5A.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of capturing CO₂ from an environment, wherein the method comprises:
associating the environment with a porous carbon material,
wherein the porous carbon material comprises a plurality of pores and a plurality of nucleophilic moieties, and
wherein the associating results in sorption of the CO₂ to the porous carbon material.

2. The method of claim 1, wherein the environment is selected from the group consisting of industrial gas streams, natural gas streams, natural gas wells, industrial gas wells, oil and gas fields, and combinations thereof.

3. The method of claim 1, wherein the environment is a pressurized environment.

4. The method of claim 3, wherein the environment has a total pressure higher than atmospheric pressure.

5. The method of claim 3, wherein the environment has a total pressure of about 5 bar to about 500 bar.

6. The method of claim 1, wherein the associating occurs by placing the porous carbon material at or near the environment.

7. The method of claim 1, wherein the associating occurs by flowing the environment through a structure that contains the porous carbon materials.

8. The method of claim 1, wherein the sorption of the CO₂ to the porous carbon material occurs by at least one of absorption, adsorption, ionic interactions, physisorption, chemisorption, covalent bonding, non-covalent bonding, hydrogen bonding, van der Waals interactions, and combinations thereof.

9. The method of claim 1, wherein the sorption of the CO₂ to the porous carbon material occurs above atmospheric pressure.

10. The method of claim 1, wherein the sorption of the CO₂ to the porous carbon material occurs at total pressures ranging from about 5 bar to about500 bar.

11. The method of claim 1, wherein the sorption of the CO₂ to the porous carbon material occurs at a partial CO₂ pressure of about 0.1 bar to about 100 bar.

12. The method of claim 1, wherein the sorption of the CO₂ to the porous carbon material occurs without heating the porous carbon material.

13. The method of claim 1, wherein the sorption of the CO₂ to the porous carbon material occurs selectively over hydrocarbons in the environment.

14. The method of claim 13, wherein the molecular ratio of sorbed CO₂ to sorbed hydrocarbons in the porous carbon material is greater than about 2

15. The method of claim 1, wherein the CO₂ is converted to poly(CO₂) within the pores of the porous carbon materials

16. The method of claim 1, further comprising a step of releasing the captured CO₂ from the porous carbon material.

17. The method of claim 16, wherein the releasing occurs by decreasing the pressure of the environment.

18. The method of claim 16, wherein the releasing occurs by placing the porous carbon material in a second environment, wherein the second environment has a lower pressure than the environment where CO₂ capture occurred.

19. The method of claim 16, wherein the releasing occurs at or below atmospheric pressure.

20. The method of claim 16, wherein the releasing occurs at total pressures ranging from about 0 bar to about 100 bar.

21. The method of claim 16, wherein the releasing occurs at the same temperature at which CO₂ sorption occurred.

22. The method of claim 16, wherein the releasing occurs without heating the porous carbon material.

23. The method of claim 16, wherein the releasing occurs through depolymerization of formed poly(CO₂).

24. The method of claim 16, further comprising a step of disposing the released CO₂.

25. The method of claim 16, further comprising a step of reusing the porous carbon material after the releasing step to capture additional CO₂ from an environment.

26. The method of claim 1, wherein the porous carbon material is selected from the group consisting of nucleophilic polymers, polypeptides, proteins, waste materials, nitrogen-containing porous carbon materials, sulfur-containing porous carbon materials, metal-containing porous carbon materials, metal-oxide containing porous carbon materials, metal sulfide-containing porous carbon materials, phosphorus containing porous carbon materials, and combinations thereof.

27. The method of claim 1, wherein the porous carbon material comprises a nucleophilic polymer.

28. The method of claim 27, wherein the nucleophilic polymer is selected from the group consisting of nitrogen-containing polymers, sulfur-containing polymers, polythiophene (PTH), polythiophene-methanol (2-(hydroxymethyl)thiophene), polyacrylonitrile (PAN), polypyrrole, and combinations thereof.

29. The method of claim 27, wherein the nucleophilic polymer is carbonized.

30. The method of claim 27, wherein the nucleophilic polymer is reduced.

31. The method of claim 1, wherein the nucleophilic moieties are part of the porous carbon material.

32. The method of claim 1, wherein the nucleophilic moieties are embedded within the plurality of the pores of the porous carbon material.

33. The method of claim 1, wherein the nucleophilic moieties are selected from the group consisting of primary nucleophiles, secondary nucleophiles, tertiary nucleophiles and combinations thereof.

34. The method of claim 1, wherein the nucleophilic moieties are selected from the group consisting of oxygen-containing moieties, sulfur-containing moieties, metal-containing moieties, metal oxide-containing moieties, metal sulfide-containing moieties, nitrogen-containing moieties, phosphorus-containing moieties, and combinations thereof.

35. The method of claim 1, wherein the nucleophilic moieties comprise nitrogen-containing moieties.

36. The method of claim 35, wherein the nitrogen-containing moieties are selected from the group consisting of primary amines, secondary amines, tertiary amines, nitrogen oxides, and combinations thereof.

37. The method of claim 1, wherein the nucleophilic moieties comprise sulfur-containing moieties.

38. The method of claim 37, wherein the sulfur-containing moieties are selected from the group consisting of primary sulfurs, secondary sulfurs, sulfur oxides, and combinations thereof.

39. The method of claim 1, wherein the porous carbon material has surface areas ranging from about 1,000 m²/g to about 3,000 m²/g.

40. The method of claim 1, wherein the plurality of pores in the porous carbon material comprise diameters ranging from about 5 nm to about 100 nm.

41. The method of claim 1, wherein the plurality of pores in the porous carbon material comprise volumes ranging from about 1 cm³/g to about 10 cm³/g.

42. The method of claim 1, wherein the porous carbon material has a density ranging from about 0.3 g/cm³ to about 4 g/cm³.

43. The method of claim 1, wherein the porous carbon material has a CO₂ sorption capacity ranging from about 10% to about 200% of the porous carbon material weight.

44. The method of claim 1, wherein the porous carbon material has a CO₂ sorption capacity of about 55% to about 90% of the porous carbon material weight.

45. A porous carbon material for CO₂ capture, wherein the porous carbon material comprises a plurality of pores and a plurality of nucleophilic moieties.

46. The porous carbon material of claim 45, wherein the porous carbon material is selected from the group consisting of nucleophilic polymers, polypeptides, proteins, waste materials, nitrogen-containing porous carbon materials, sulfur-containing porous carbon materials, metal-containing porous carbon materials, metal-oxide containing porous carbon materials, metal sulfide containing porous carbon materials, phosphorus containing porous materials, and combinations thereof.

47. The porous carbon material of claim 45, wherein the porous carbon material comprises a nucleophilic polymer.

48. The porous carbon material of claim 47, wherein the nucleophilic polymer is selected from the group consisting of nitrogen-containing polymers, sulfur-containing polymers, polythiophene (PTH), polythiophene-methanol (2-(hydroxymethyl)thiophene), polyacrylonitrile (PAN), polypyrrole, and combinations thereof.

49. The porous carbon material of claim 48, wherein the nucleophilic polymer is carbonized.

50. The porous carbon material of claim 48, wherein the nucleophilic polymer is reduced.

51. The porous carbon material of claim 45, wherein the nucleophilic moieties are part of the porous carbon material.

52. The porous carbon material of claim 45, wherein the nucleophilic moieties are embedded within the plurality of the pores of the porous carbon material.

53. The porous carbon material of claim 45, wherein the nucleophilic moieties are selected from the group consisting of primary nucleophiles, secondary nucleophiles, tertiary nucleophiles and combinations thereof.

54. The porous carbon material of claim 45, wherein the nucleophilic moieties are selected from the group consisting of oxygen-containing moieties, sulfur-containing moieties, metal-containing moieties, metal oxide-containing moieties, metal sulfide-containing moieties, phosphorus containing moieties, nitrogen-containing moieties, and combinations thereof.

55. The porous carbon material of claim 45, wherein the nucleophilic moieties comprise nitrogen-containing moieties.

56. The porous carbon material of claim 45, wherein the nitrogen-containing moieties are selected from the group consisting of primary amines, secondary amines, tertiary amines, nitrogen oxides, and combinations thereof.

57. The porous carbon material of claim 45, wherein the nucleophilic moieties comprise sulfur-containing moieties.

58. The porous carbon material of claim 45, wherein the sulfur-containing moieties are selected from the group consisting of primary sulfurs, secondary sulfurs, sulfur oxides, and combinations thereof.

59. The porous carbon material of claim 45, wherein the porous carbon material has surface areas ranging from about 1,000 m²/g to about 3,000 m²/g.

60. The porous carbon material of claim 45, wherein the plurality of pores in the porous carbon material comprise diameters ranging from about 5 nm to about 100 nm.

61. The porous carbon material of claim 45, wherein the plurality of pores in the porous carbon material comprise volumes ranging from about 1 cm³/g to about 10 cm³/g.

62. The porous carbon material of claim 45, wherein the porous carbon material has a density ranging from about 0.3 g/cm³ to about 4 g/cm³.

63. The porous carbon material of claim 45, wherein the porous carbon material has a CO₂ sorption capacity ranging from about 10% to about 200% of the porous carbon material weight.

64. The porous carbon material of claim 45, wherein the porous carbon material has a CO₂ sorption capacity of about 55% to about 90% of the porous carbon material weight.
